(19) United States
(12) Patent Application Publication
(10) Pub. No.: US 2022/0188924 A1
(43) Pub. Date: Jun. 16, 2022

(54) A METHOD AND SYSTEM FOR THE SECURE TRANSMISSION OF FUNDS

(71) Applicant: Andrew SMITH, Bromley, Kent (GB)

(72) Inventors: Andrew SMITH, Bromley (GB); Joseph Gordon COOPER, Halifax (CA); Nick OGDEN, St Clements, Jersey (GB)

(21) Appl. No.: 17/275,837

(22) PCT Filed: Sep. 2, 2019
(86) PCT No.: PCT/IB2019/057390

§ 371 Date: Mar. 12, 2021

(51) Int. Cl. G06Q 40/04; G06Q 20/22

(52) U.S. Cl. CPC G06Q 40/04; G06Q 20/223

(57) ABSTRACT

Peer-to-peer currency exchanges support fast transfers and provides substantial savings over banks.

P2P exchange companies are growing fast pace and offer a lower-cost alternative to individuals and small businesses. However, the P2P currency exchange marketplace does not fully protect their customers due to their cross jurisdictional liquidity matched business model.

A proprietary process and network of secure IT platform delivers an irrevocable international liquidity and complementary payment network protecting bank participants from Herstatt risk using concurrently delivered global interbank real-time liquidity assured transactional capability.

### FIELD OF THE INVENTION

The present invention relates to a method and system for the secure transmission of funds.

### BACKGROUND

The interbank or foreign exchange transactions marketplace is a top-level foreign exchange market where banks exchange different currencies. Banks can either deal with one another directly, or through electronic brokering platforms. The electronic broking services (EBS) is an example of an electronic brokering platform that connects hundreds of banks around the world enabling them to transfer a currency of one state to a different currency of another state.

The interbank market is an important segment of the foreign exchange market. It is a wholesale market through which most currency transactions are brokered. The interbank or foreign exchange market developed electronic messages with the introduction of the SWIFT network in the early 1970s to replace telex messaging services.

In 1973, 239 banks from 15 countries collaborated to solve a common problem, namely: how to communicate securely concerning cross-border payments. The 239 banks formed a cooperative utility known as the Society for Worldwide Interbank Financial Telecommunication (SWIFT) which is headquartered in Belgium. SWIFT went live with its messaging services in 1977, replacing telex technology that was then in widespread use. The SWIFT banking system rapidly became a reliable and trusted banking system for institutions all around the world.

The main components of the SWIFT service includes a messaging platform, a computer system to validate and route messages, and a set of message standards. The standards were developed to allow for a common understanding of data across linguistic, states' and systems' boundaries and to permit seamless, automated transmission, receipt and processing of communications exchanged between users. Herstatt bank, founded in 1955, and by 1974 had assets of over 2 billion Deutsche marks (DM). Herstatt bank became a significant participant in the foreign exchange markets.

During 1973 and 1974 the US dollar experienced significant volatility. Around the same time Herstatt bank had accumulated DM470 million in losses, compared with capital reserves of only DM44 million. In June 1974 German regulators forced the Herstatt bank into liquidation. Earlier on the same day, a number of banks released payment of Deutsche marks to Herstatt bank in Frankfurt in exchange for US dollars (USD) that were to be delivered in New York. However, Herstatt bank was closed at 16:30 German time, which was 10:30 New York time.

Because of time zone differences, Herstatt ceased operations between the times of the respective payments. Consequently the counterparty banks in New York did not receive their USD payments. This type of settlement risk, in which one party in a foreign exchange trades pays out the currency it sold but does not receive the currency it bought, is therefore sometimes called Herstatt risk.

Responding to cross-jurisdictional implications of the Herstatt debacle, the G-10 group of countries formed a standing committee under the auspices of the Bank for International Settlements (BIS). Called the Basel Committee on banking supervision, the committee comprises representatives from central banks and regulatory authorities from the various G-10 member states.

The failure of Herstatt bank was a key factor that led to the worldwide implementation of real-time gross settlement (RTGS) systems, which ensure that payments between one bank and another are executed in real-time and are considered final. The work on these issues was coordinated by the Basel Committee on Banking Supervision under the Bank of International Settlements.

The continuous linked settlement (CLS) platform was launched almost 30 years later in 2002. This payment versus payment (PVP) process enables member banks to trade foreign currencies without assuming the settlement risk associated with the process, whereby a counterparty might fail or default before delivering their leg of the forward transaction.

Despite the Herstatt aftermath, the development of CLS, and the global financial crisis of 2007, there is still no interconnected RTGS system. Consequently this means that global real time interbank payments are still transacted with a degree of risk.

Herstatt risk remains and the ability for central banks to resolve banks operating so-called nostro and vostro accounts is challenged.

Following events surrounding the so-called Herstatt incident in 1974, and other events since then, including the global financial crisis of 2007-2009 a safer, more reliable and real-time capability to conduct interbank or foreign exchange transactions has been sought.

Currently the way in which international banking payments are transacted are as follows. For international payments, if two banks are not clearing with each other directly (for example as traditional nostro/vostro banks), then the transaction is routed via one or more correspondent bank(s). The assumption in this arrangement is that both banks have arrangements with the, or each, correspondent bank in order to clear foreign payments. This adds to payment complexity, additional costs and transactional delay, thereby increasing risk of a banking failure due to Herstatt risk because at no time is real liquidity identified with absolute certainty.

In a payment cycle a beneficiary bank is the recipient bank, into which a customer receives a payment into their bank account. An intermediary or correspondent bank is a third-party bank used by the beneficiary bank to facilitate international transfer and settlement of funds to or from a third party bank.

Intermediary banks are also third-party banks that are used to facilitate international transfer and settlement of funds between two banks. A main difference between intermediary banks and correspondent banks is that correspondent banks normally choose to transact in more currencies than intermediary banks.

Correspondent and intermediary banks both serve as third-party banks that coordinate with beneficiary banks to facilitate international fund transfers and transaction settlements. In both cases, a person or entity requires a customer to have an account at an issuing bank; that bank then uses a correspondent or intermediary bank to complete the process of moving funds to a beneficiary bank in a different currency.

However differences between correspondent and intermediary banks are not consistent. Differences depend on several factors including where in the world an account holder is based; and to what extent correspondent banks are either distinct from intermediary banks or whether they can be treated as a type of intermediary bank. In some instances a correspondent banks may be indistinguishable from an intermediary bank.

A correspondent bank provides services on behalf of another bank and often serves in the capacity of a ‘middleman’ between an issuing bank and a recipient bank. Domestic banks often use correspondent banks as their agent in a different state in order to complete a final transaction that either commences or is concluded in a different state to the state where the issuing bank is located.

A correspondent bank can execute a number of transactions on behalf of a domestic bank. The transactions include completing wire transfers, accepting deposits, serving as transfer agents, and coordinating documents for another bank.

Intermediary bank serves a similar role to that of a correspondent bank. An intermediary bank is also a middleman between an issuing bank and a recipient bank which is sometimes located in a different country to the recipient bank.

An intermediary bank is often required when international wire transfers are transacted between two banks. The banks are often in different countries that do not have an established financial relationship with one another. Intermediary banks send cash to complete foreign transactions, but the transactions are just for one currency. Usually, in this instance, a domestic bank is too small to handle international transfers, so it reaches out to an intermediary bank.

In some states, for example the United States of America and some other parts of the world, there is sometimes a delineation between specific roles for intermediary and a correspondent bank.

One difference between intermediary and correspondent banks is that correspondent banks are responsible for transactions that involve several currencies. For example, if one party making a money transfer is based in the USA, sending money to a party in Denmark, a correspondent bank is normally engaged be responsible for all transactions from the US Dollar to the Danish Krone. A correspondent bank in Denmark that handles foreign currency collects the money for the recipient.

Wire transfers are an electronic method of sending cash to another person or entity are very common transactions with all banks, but international wire transfers are costlier and more difficult to execute.

In certain parts of the world, such as Australia or EU member nations, banks that deal in international transfers are called intermediary banks. No distinction is made between intermediary and correspondent banks.

Most international wire transfers are handled through the Society for Worldwide Interbank Financial Telecommunication (SWIFT) network. SWIFT was founded in 1970. If there no working relationship between the issuing and receiving bank, the originating bank can search the SWIFT network for a correspondent or intermediary bank that has arrangements with both financial institutions.

A correspondent bank is most typically used in international buy, sell or money transfer transactions to facilitate foreign currency exchange and payments.

A SWIFT correspondent bank is a bank in one country that is authorized to provide services for another bank or financial institution in a foreign country. The most common services provided by a correspondent bank are currency exchange, handling business transactions and trade documentation, and money transfers.

Correspondent banking works through an agreement between a foreign and domestic bank where a correspondent account, usually referred to as a vostro or nostro account, is established at one bank for the other. Correspondent banking typically involves the two banks establishing reciprocal accounts with each other. These reciprocal accounts are established to enable the domestic bank to make payments or money transfers on behalf of the foreign bank.

Such correspondent accounts enable banks to handle international financial transactions for their customers that ordinarily require foreign currency exchange, such as those that commonly occur between an exporting business in one country to an importer in another country.

### PRIOR ART

U.S. Pat. No. 10,140,659 (Chicago Mercantile Exchange) describes a system which improves the efficiency of an electronic trading system for interest rate swaps (“IRS”) by allowing for IRS contracts to be funded in a base currency while related cash flows are denominated in a local currency different from the base currency. The system ensures cash flows are netted and offset, thereby minimizing the magnitude of funds needed to be moved and so reducing the number of transactions processed by the trading system.

The aforementioned system is useful in that it provides a system that reduces Herstatt risk in certain areas of currency exchange, over existing banking networks, but it does not address the growing market of so called challenger banks, one of which is referred to as a peer-to-peer bank.

Since around 2010 a new wave of Internet-based banks, called peer-to-peer (P2P) banks have started to emerge. These foreign currency exchange services are threatening traditional banks by cutting their fees and so are becoming ever more dominant in certain markets.

Through online P2P platforms, individuals can find and safely exchange currency with individuals in other countries at much lower costs than traditional banks have charged. Most online P2P companies claim to provide up to 90 percent cost saving to clients on international exchange and transfer fee.

Banks and brokers usually charge several percent on the total amount exchanged as well as a transfer fee. P2P currency exchanges companies such as CurrencyFair (Trade Mark), Kantox (Trade Mark), and TransferWise (Trade Mark) allow users to register online for an account and deposit money into it. Depending on the particular P2P bank, users can accept a given exchange rate or bid on an exchange rate of their choosing. Once a user identifies an acceptable rate, the platform identifies a match with a willing buyer and transfers funds from one to the other. Funds are usually remitted (clear) within a day or so by way of a domestic money transfer in the buyer's bank account.

Using these type of accounts funds never actually leaves the country of origin but instead a are simply exchanged between users. Users can send money to any person, business account, or even their own account in another country.

The P2P provider may even step in to provide liquidity if there is a shortfall on one side or if there are no good currency exchange matches. In such situations, the P2P platform typically may levy an additional fee or handling charge. For example, if there is no suitable currency match, one P2P platform, charges 0.5% of the transaction and performs the exchange using its own funds. This is slightly more than the typical 0.35% percent for standard peer to peer matches.

Another P2P platform charges a flat fee of 1.5% in such situations as well as offering the option of remittance through a prepaid credit card which it sends to a user which appeals to travellers and tourists.

Although P2P foreign currency exchanges are still relatively new, and they are most convenient for changing common currencies like dollars, pounds, euros, and yen, they are gaining in acceptance and popularity. Because the platforms on which they operate depend on connecting individual users in different countries, users of smaller currencies may not immediately find a good corresponding match. Also currency users in some countries may find that certain platforms do not yet deal in their local currency.

An attractive feature of P2P foreign currency transfer is its cost savings. By sidestepping banks and brokers, these platforms provide currency exchange at a much lower rate and for regular users, there can be a considerable saving over existing international transfers compared to most banks where currently the fee charged may be between 2% to 5% of the transactions. It is no surprise therefore that these P2P platforms are growing and becoming more popular.

Also unlike traditional banks users can access an online P2P account at any time from anywhere. The accounts are easy to use for both small and large sums and the transactions clear quickly although some accounts require surcharge for guaranteed same-day or the next-day transfers).

More recently P2P foreign currency exchanges are now offering their services to businesses. Therefore given that peer-to-peer currency exchanges hardly existed in 2005. These new banks are now starting to transact substantial sums of money. Recently the P2Pexchange CurrencyFair (Trade Mark) reported running tally of funds handled, at around €1.5 billion January 2015.

Many P2P foreign currency exchange firms are either based in or have registered offices in the United Kingdom. As registered money service businesses, they are administered by the UK government revenue and customs (HMRC) and must follow observe and comply with various strict regulations.

Within the UK financial conduct authority (FCA) there are two categories: registered (smaller) firms and authorized (larger) firms. Authorized firms must separate their customers' money from their own at the end of each day in a process known as ringfencing. This provides better security for customers and a higher chance of recovering money should a bank fail or company default.

Firms are licensed as money transmitters by their respective state banking departments and must follow the anti-money laundering (AML) policies. Some companies are regulated by more than one country. For example CurrencyFair (Trade Mark) is based in Australia and is regulated by the Australian Securities and Investment Commission (ASIC). CurrencyFair (Trade Mark) also has a registered office in Ireland where it is regulated by the central bank of the Republic of Ireland.

In the USA, the US Department of the Treasury's Financial Crimes Enforcement Network (FINCEN) oversees P2P currency exchange firms.

Firms that transfer higher volumes of transactions and funds tend to have greater customer liquidity. This enables them to offer better rates, quicker conversions, and smoother transfers. Increasingly such larger firms will offer a wider range of currencies.

Because of regulatory requirements P2P firms are required to keep customer funds in segregated accounts and not common accounts. Should a firm have financial difficulty, only segregated accounts offer protection. However if liquidity has been transferred between countries to balance trading positions, the ability to recover funds in flight may disappear. Hence there is a potential for these relatively new banking firms to be exposed to Herstatt risk.

As P2P exchanges are higher risk than regulated banks they present a growing risk and one that financial regulators are unaware, as regulators are unable to account for or audit the increasing amount of funds being transacted through peer-to-peer exchanges. Consequently there is a risk of another financial crisis being triggered in the event of a collapse or major default.

An aim of the invention is to provide a system that operates across borders and in real-time.

Another aim of the invention is to provide a system that guarantees the existence of funds and ensures funds are transferred, thereby reducing the risk of banks of being exposed to Herstatt risk.

### SUMMARY OF THE INVENTION

According to a first aspect of the present invention there is provided a computer implemented method for use with a secure money transfer system which is operative to transfer funds, in a first currency, from a first (sending) bank account, at a first location, to a second (recipient) bank account at a second location, in which:

a first processing means identifies a sum of funds in the first account from where an amount of money is to be transferred;

a protocol buffer generates a block code in respect of the sum of funds to be transferred;

a memory stores the block code which includes data: identifying the sum of funds, a unique account identifier of the first sending bank account;

a communication device establishes a secure communication channel with a recipient account, at a recipient bank, to where the sum of funds is to be transferred;

a local transmission protocol buffer transmits the block code to a remote recipient protocol buffer via the secure communication channel;

the remote recipient protocol buffer receives the block code and transmits the block code to a bilateral synchroniser which relays account data and a liquidity check derived from the sending bank account to the recipient bank account;

a synchroniser synchronises the sending and receiving bank accounts thereby establishing a direct high speed connection therebetween

upon receipt of an authorisation signal from the synchroniser a second processing means is operative to identify and ring-fence the sum of funds in the first account from where the sum of funds is to be transferred;

when the sum of funds identified in the block code corresponds with the ring-fenced sum of funds, an authorised user (account holder) is offered a transaction option for a predefined time period;

upon receipt of an input from the authorised user (account holder), confirming acceptance of the transaction option, a reciprocal arrangement is established between the recipient bank account and the sending bank accounts for establishing a two way irrevocable authentication event thereby enabling funds to be transferred.

According to a second aspect of the present invention there is provided a system for transacting a secure money transfer which is operative to transfer funds, in a first currency, from a first (sending) bank account, at a first location, to a second (recipient) bank account at a second location, in which:

a first processing means identifies a sum of funds in the first account from where an amount of money is to be transferred;

a protocol buffer generates a block code in respect of the sum of funds to be transferred;

a memory stores the block code which includes data: identifying the sum of funds, a unique account identifier of the first sending bank account;

a communication device establishes a secure communication channel with a recipient account, at a recipient bank, to where the sum of funds is to be transferred;

a local transmission protocol buffer transmits the block code to a remote recipient protocol buffer via the secure communication channel;

the remote recipient protocol buffer receives the block code and transmits the block code to a bilateral synchroniser which relays account data and a liquidity check derived from the sending bank account to the recipient bank account;

a synchroniser synchronises the sending and receiving bank accounts thereby establishing a direct high speed connection therebetween;

upon receipt of an authorisation signal from the synchroniser a second processing means is operative to identify and ringfences the sum of funds in the first account from where the sum of funds is to be transferred;

when the sum of funds identified in the block code corresponds with the ringfenced sum of funds, an authorised user (account holder) is offered a transaction option for a predefined time period;

upon receipt of an input from the authorised user (account holder), confirming acceptance of the transaction option, a reciprocal arrangement is established between the recipient bank account and the sending bank accounts for establishing a two way irrevocable authentication event thereby enabling funds to be transferred.

Therefore if a customer of Bank A wishes to make a payment to another country, to a customer of Bank B, it is critical that bank B is guaranteed that Bank A is solvent and has liquidity available to transfer in order to meet a transactional liability instantly. By making the payment instantaneous and against guaranteed liquidity, netting and longer cycle settlement risk is removed completely.

A fixed fee based upon the assured funds ringfenced between the banks may be charged by an operator.

An advantage of the invention is that it minimises transmission latency and is aware of funds (liquidity) within both the sending and recipient banks. This consequently removes Herstatt risk.

The invention therefore delivers an interbank system that operates cross border and in real-time and which verifies a liquidity position; rather than using simple interbank messaging and associated messaging an inherent delay associated therewith.

Because the invention ringfences a sum of funds, an authorised user (account holder) is offered a transaction option for a predefined time period with certainty because the sending bank is able to deliver, with certainty, the verifiable sum.

The establishment of a so-called ‘liquidity block’ of funds which identifies, verifies and effectively ringfences funds, prior to a transactional event, guarantees the existence of the funds and enables subsequent logging and reporting of movement of funds across borders and in multiple currencies, in real-time.

Preferably the funds that are paid into the second recipient bank account are paid in a different currency to the first currency.

In some embodiments a transmission is made to and/or from a protocol buffer by using an encryption engine. Ideally the encryption engine operates in accordance with a public private key encryption system and/or an encryption algorithm, such as for example, an RSA cryptographic algorithm.

The unique account identifier of a bank is typically the group comprising: an account number and a bank sort code; a bank identifier code (BIC); an international bank account number (IBAN); and a country code number. An account can also be derived from the identity of an account holder, typically via a decentralised identity (DID).

In a preferred embodiment a user (account holder) is offered a transaction option for a predefined time period. This provides a user to change their mind and allows for an interval of time, typically up to 30 seconds, preferably up to 20 seconds, during which distraction can occur without a transaction cancelling.

In the situation where a user (account holder) does not accept the transaction option offered within the predefined time period, a recalculation of the offer is derived by obtaining an updated liquidity check from the sending bank account. The transaction option is ideally offered to the user in a selectable currency recognised by the second (recipient) bank at the second location.

In some embodiments upon receipt of an input signal, which includes an authorisation command from the user (account holder), that confirms acceptance of a transaction, the funds to be transferred from the first (sending) bank account are ringfenced.

Ideally a processor is operative to determine at least a settlement charge which may be based upon the ringfenced sum of funds. Ideally the processor is also operative to determine a transaction charge which is based upon the value of a liquidity block that is applied by the sending and/or receiving bank. In other embodiments the processor determines the value of the liquidity block based upon an interbank risk factor.

Ideally at least one gateway is established for connecting a proprietary payment system to the secure communication channel which may include: a TCP/IP routing protocol gateway; a virtual private network (VPN), remote protocol buffer, web sockets and a SWIFT payment network.

Optionally data relating to transactional events is stored in databases or in a data lake configuration which is optionally populated in real time. Databases may log communications from/to a protocol buffer to/from a bilateral synchroniser.

Optionally a web-based portal is provided which is configured to deliver a menu to a display viewable by a user and from which a user command is transmitted to a communication network. In another embodiment application specific software (APP) is supplied to a mobile device, tablet or laptop which is operative under control of the software to enable a mobile money transfer to be made in accordance with the invention.

A facility for currency matching is optionally achieved by way of a routing engine that identifies at least one participating bank and a specified currency.

In some embodiments a participant bank employs a point-to-point encryption and communication network between protocol buffer components. The protocol buffer may be configured to operate in accordance with an encryption offloading sequence which transfers internal communications data, operating over an encrypted private infrastructure, to a public or proprietary network.

Optionally an audit log of stored data is obtained which includes data relating to communications between protocol buffers from/to a protocol buffer to/from a bilateral synchroniser.

Edge encryption of data may be performed at any point in a communication sequence.

It is further understood that a distributed digital ledger of a consensus of replicated, shared, and synchronized digital data may be incorporated within and relied on by the system. The distributed ledger is typically geographically spread across a number of independent sites and/or in different countries and/or in independent institutions. Such as distributed digital ledger is often referred to as ‘block chain’ and may be relied upon to record transactions or digital interactions and ensure transparency and security to businesses by authenticating and verifying users and transactions.

It is understood that the aforementioned preferred or optional features of the method may be included in the system as desired and in accordance with requirements specified by the skilled person.

Likewise aspects and components of the system, referred to, may be included in one or more method claims.

Variation may be made to the invention by providing application specific software, in the form of an APP, which is downloadable onto a mobile electronic device, such as a mobile telephone, tablet or laptop, so as to configure the aforesaid a mobile telephone, tablet or laptop to communicate with, and operate as part of, the aforementioned system, thereby enabling a user to transfer funds securely to a desired account.

It is appreciated that the system may include a mobile telephone, tablet or laptop, includes a display that is operative in accordance with software and which is configured to communicate with the system.

Ideally the mobile telephone, tablet or laptop has a biometric device that is operable by an authorised user to provide an input from the authorised user (account holder), confirming acceptance of a transaction.

Preferred embodiments of the invention will now be described, by way of example only, and with reference to the Figures in which:

### BRIEF DESCRIPTION OF THE FIGURES

FIG. 1 there is shown a diagrammatical representation of a typical example of correspondent banking;

FIG. 2 shows an example of a customer of a bank in one country needs to pay for products purchased from a supplier in another country;

FIG. 3 illustrates how a bank holding liquidity accounts on behalf of other participating banks works to ensure accounts are kept in synchronisation with a preferred embodiment of the RTGS global network;

FIG. 4 shows an example of how the invention enables identified liquidity requirements to be passed over the RIGS global platform and platform and how liquidity is blocked/locked with a secondary bank;

FIG. 5 shows how the invention locks necessary liquidity required to complete a transaction at both the sending and receiving banks and how status messages are relayed over the network;

FIG. 6 shows an example of a participant bank that is connected directly to a central bank, and the local payment systems within a specific jurisdiction;

FIG. 7 shows diagrammatically the role of central banks and how they operate in a preferred embodiment of the RTGS global system;

FIG. 8 depicts an example of a correspondent banking model within the RTGS global system;

FIG. 9 shows an overall diagrammatic view of an example of an RTGS global network security system;

FIGS. 10, 11 and 12 show diagrammatical representations of a sequence of transactions involved in a payment from a first participant bank whose membership is within the UK jurisdiction (fiat currency GBP) and a European bank; and

FIG. 13 is a diagrammatic representation showing how the RIGS global network is used for participants to purchase liquidity in fiat currency across the network of participant banks.

### DETAILED DESCRIPTION OF PREFERRED EMBODIMENTS OF THE INVENTION

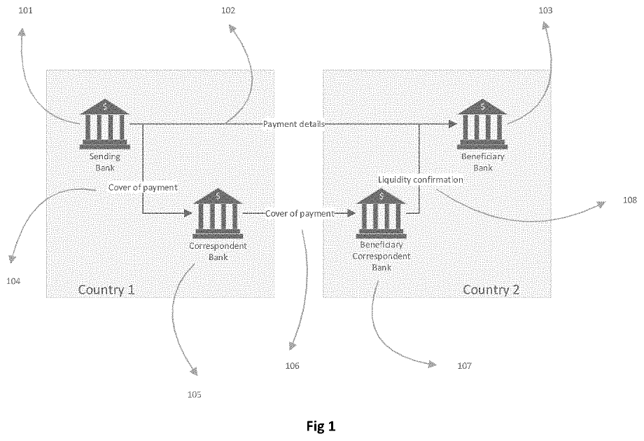

So as to better appreciate the invention there is now described, with reference to FIG. 1, an example illustrating how correspondent banking, such as a SWIFT payment is made. The number of correspondent banks in the chain can vary widely, depending on jurisdiction. In FIG. 1 only two countries are illustrated, in many examples of correspondence banking, multiple countries may be involved in order to complete a transaction and ensure a final payment.

In FIG. 1 a bank is shown which is sending the funds 101 from an account from which funds are being drawn. A proprietary SWIFT format message 102 is sent to a beneficiary bank 103. This is charged to the sending bank account 101.

The beneficiary bank 103 receives a message (MT103) which contains payment details, and also a confirmation that necessary liquidity (funds) have been received at correspondent banks 107 and 108. The correspondent banks 107 and 108 also make onward payments in a local currency in a relevant local jurisdiction. Typically these last leg payments are made by way of a conventional real-time gross settlement (RTGS) platform or local payment system, which ensures continuity of settling payments on an individual order basis.

A proprietary SWIFT message 104 is sent to the correspondent bank 105 of the sending bank. This is sometimes referred to as a cover of payment (MT202COV). A message charge is usually levied on the sending bank for the cover of payment message.

The sending banks correspondent bank 105 receives the cover of payment message and processes the transaction. Balance adjustments are completed and the payment 106 is processed. The cover of payment message (MT202COV) is retransmitted to a beneficiary correspondent bank 107. The sending correspondent bank is charged a SWIFT message.

The cover of payment message is received and processed by a processor 107. At this instant necessary balance adjustments are made and the confirmation of liquid (funds received) is then transmitted to the beneficiary's bank account 103.

An additional MT202COV message 108 is sent to the beneficiary bank 103, or a proprietary SWIFT message MT910 is sent which confirms liquidity has been received. The beneficiary correspondent bank 107 is charged for this proprietary SWIFT message MT910.

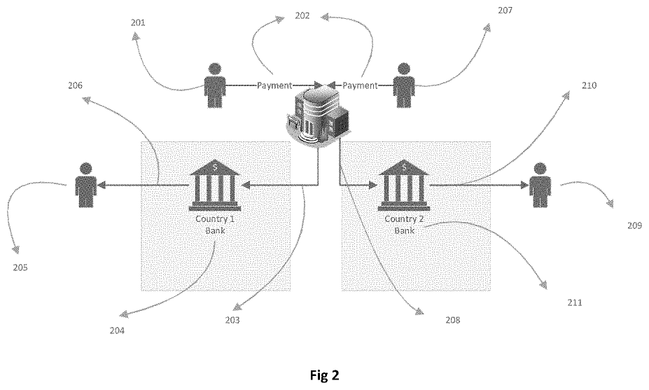

Referring to FIG. 2 there is shown a person 201 at a first location Country 1 who is using an existing money transfer service to send money abroad. The person 201 makes a payment to a provider of foreign exchange (FX) service such as a TransferWise (Trade Mark) which is a type of P2P service as described above.

For example, suppose Mary is an American working in Paris for a year and earning euros. She needs to convert her euros to dollars and place them in her American bank account in order to pay her American mortgage. Meanwhile, John who is based in Los Angeles wants to convert dollars into euros to send to his son who is studying in France. Instead of going to a bank, Mary and John sign up for accounts on a P2P currency exchange website and their respective P2P accounts are matched, albeit anonymously.

Mary deposits euros into her P2P account and John deposits dollars into his. The P2P website shows Mary and John how many dollars or euros they will receive for their transfers, and they each confirm the transfer. On settlement the P2P currency exchange service transfers John's dollars into Mary's American bank account and at the same time, Mary's euros will be transferred to John's son in France.

Payment 202 is made into the business that is providing the service business bank account. Funds 203 are deposited in the businesses bank account in a local fiat currency. A businesses bank 204 is responsible for holding the funds. A customer 205 who is waiting to receive a cross border payment receives funds in the local fiat currency.

Payment 206 is made from the business 204 (service provider) to the customer 205 waiting to receive a cross border payment. The payment is made from the businesses bank account held with the bank 204. This is essentially funds received by customers in that local jurisdiction ready for cross border payments. So, the deposit taken by 201 is used in part, or full, to fulfil the fiat currency payment to 205.

A customer 207 is in a second jurisdiction that is using the service to send money abroad makes a payment to a provider of a foreign exchange service such as TransferWise (Trade Mark).

Payment 202 is made into the business that is providing the services business bank account 211. A customer 209 who is waiting to receive a cross border payment, receives funds in a local fiat currency. Thus a payment 210 is made from the business (service provider) to the customer across a border.

The payment is made from a business bank account held with the provider's bank 211. So a deposit 207 is taken and is used in part, or full, to fulfil a fiat currency payment to a recipient 209. The provider's bank account 211 is typically located in a second jurisdiction.

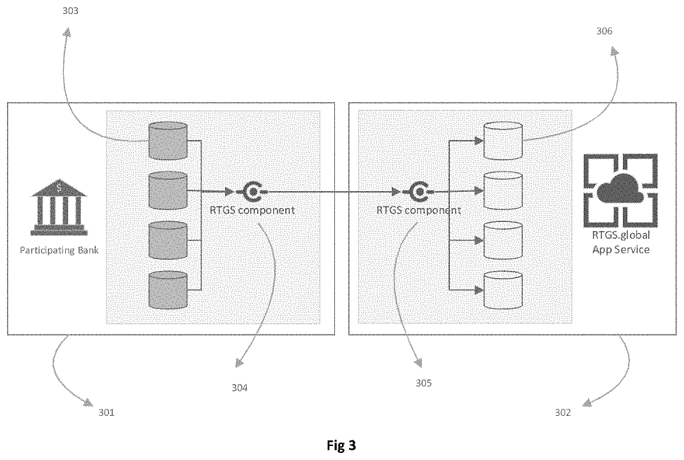

Referring now to FIGS. 3 to 9 there is illustrated a preferred embodiment of the invention, which is operative in real-time, continuously with visibility of all relevant funds of all participating parties, to enables instantaneous reconciliation of funds in order to eliminate Herstatt risk.

Referring now to FIG. 3, there is shown a system including a participating bank 301 and an RTGS global platform 302. The system enables a participant bank (either the first or second) holding liquidity accounts on behalf of other participating banks in the network. This feature of the invention ensures these accounts are kept in synchronisation with the RTGS global network.

Liquidity pools of fiat currency 303 are controlled and operated by the participating bank 301 on-behalf of it and other RTGS global participant banks. These are referred to as segregated accounts in-line with the RTGS global operating terms and conditions.

An RTGS global protocol buffer component 304 enables real-time data to be obtained from a liquidity pool and to be sent in real time to a remote recipient 105 within the RTGS global platform. A recipient protocol buffer component 305 receives real-time data feeds of liquidity from a sending buffer 304. A synchronised data-projection of liquidity 306 is obtained from the participating bank.

The invention relies on the use of a liquidity block and lock to secure, authenticate and deliver irrevocability to the transactions between banks using its global interbank network.

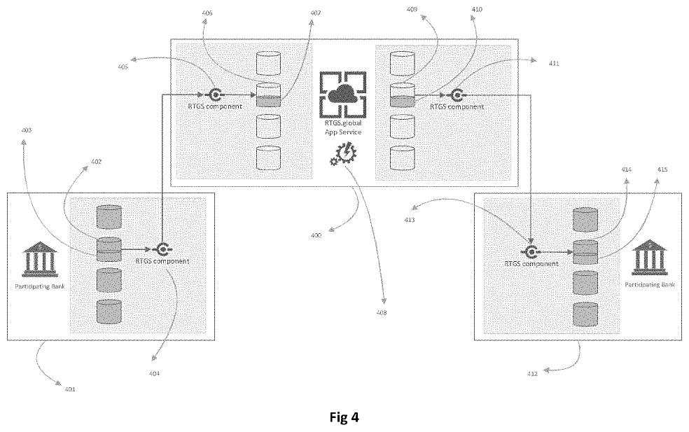

In the example shown in FIG. 4 Bank A, a UK Bank advises Bank B which is based in Europe, that bank A wishes to purchase some euros to make a transfer.

FIG. 4 shows how the RTGS global platform and network blocks/locks with a secondary bank. The necessary liquidity is locked at both banks. A liquidity lock is executed in Bank A, which is relayed as a block from Bank A to the RTGS global platform.

The platform then applies a lock on the synchronised projection of accounts in Bank A which locks necessary liquidity in Bank B. The lock is now complete and applied for the proposed transaction. This confirms to Bank B that Bank A is liquid with unencumbered, ringfenced GBP funds, and is therefore able to purchase the euros from them at no risk. The euro currency rate was already set by Bank B as part of its participation in the RTGS global network and is configured into the RTGS global platform based on the market data and any fees are due. This information was added to the unique message that establishes the liquidity lock.

Referring now to FIG. 4 there is shown an RTGS global platform 401 via which a participating bank 401 seeks to send a payment to a recipient bank 412. Liquidity pools 402 are represented in the participating bank of other participating banks (including the recipient bank 412) within the jurisdiction of the participating bank 401.

A fiat currency representation of funds to be sent to a receiving participant is shown as 403. This amount is based on the sender setting what amount of funds should be received by an ultimate beneficiary and bank 412. This amount is calculated by 408 which matches the currencies and the “selling” rate being set by the recipient bank 412.

Fees are also applied, so that the sending bank ring fences and blocks the right amount of liquid funds to complete the transaction. This process occurs automatically and in real-time locks funds for the sending bank 401 which in turn, in real-time, synchronises through the protocol buffers at 402 and 405. The liquidity block is then applied in real time synchronously to 406 in the shape of 407.

The liquidity block is then applied to the recipient bank in 409 in the form of 410 for the fiat destination currency which the recipient bank is selling to the sending bank in order to complete the transaction. These stores occur in real-time. This is synchronised with the recipient banks system by sending liquidity block data via the protocol buffers first at 411, and subsequently to the recipient bank's protocol buffer 413. The recipient bank then has the liquidity lock applied to its liquidity so that the transaction is guaranteed, in real-time.

A presence of liquidity pools 406 held by one or more participating banks within a specific jurisdiction, ensure that there is sufficient liquidity available to meet the necessary liquidity requirements 407 to facilitate a cross border payment once an exchange rate has been locked by the foreign exchange liquidity locking service 408.

The foreign exchange liquidity locking service 408 takes pre-configured participating bank rates and applies them to cross-border transactions. Once a rate is selected by the sending participating bank 401, this is time-locked and allows required liquidity calculations to be completed and a liquidity lock put in place.

Liquidity locking then flows to both participating banks 401 and 412. Once locked with RTGS global at 407 and 410, the liquidity (available balance) is decremented within RTGS global projection of liquidity, ensuring accurate liquidity for other transactions that take place. The same notification is executed within the participating banks.

A representation of the projection of liquidity pools at the sending participating bank is shown at 409 and a representation of the required liquidity that must be locked in order to facilitate a transaction is shown as 410. The funds are now referred to as locked liquidity.

The RTGS global protocol buffer component 404 and 405, ensures synchronisation with the participating bank 401. A second participating bank 412 facilitates the transaction within the jurisdiction. The RTGS global protocol buffer component 411 and 413 ensures the participating bank 412 is also in synchronisation with the RTGS global platform. In doing so, both banks 401 and 412 and the RTGS global platform remain in synchronisation, with liquidity locks being maintained in synchronisation for a predetermined time interval.

As the customer of bank 401 authorises the transaction, concurrently the liquidity account at participating bank 401 reduces in GBP value, and the liquidity account in euros at recipient bank 412 increases for bank 401. Both these movements happen in real-time and in the pre-defined currency.

The movements are also reflected in the vostro and nostro accounts structure, ensuring that participating bank 412 now holds GBP value for its transaction in sending bank 401 and has paid away the corresponding euro value on behalf of bank 401 to its customer over domestic payments rails in its country. The recipient bank 412 credits the sending bank's nostro euro account by the necessary sum of euros before paying away the funds over the domestic payment rails.

The time to complete this transaction should be less than 8 seconds, with the anticipated time spent within the RTGS platform being less than 2 seconds. This equates to an existing International electronic point of sale transactions using a VISA (Trade Mark) or MasterCard (Trade Mark) for example.

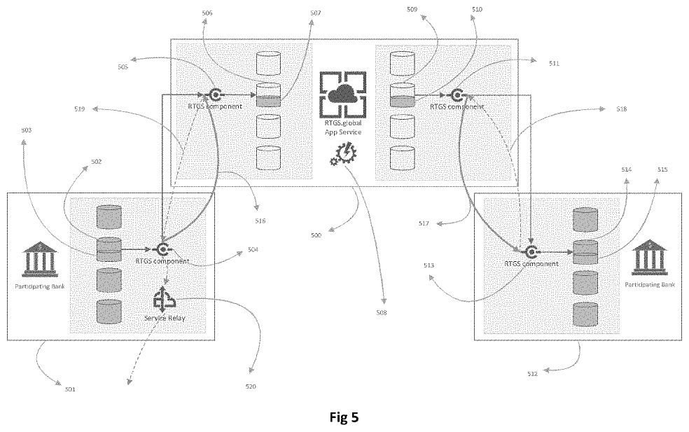

FIG. 5 is a diagram showing another embodiment of RTGS global platform 500 and how the system not only locks the necessary liquidity required to complete the transaction at both the sending and receiving banks, but also how the sending bank then processes the request to accept and complete the transaction. Participating bank 501 in this example is seeking to send a payment to 512.

Liquidity pools 502 are represented in the participating bank of other participants within that jurisdiction. Fiat currency is represented as funds 503 to be sent to a receiving participant bank 512. The posting of an RTGS global FX rate locking service 508 is shown as being executed.

The RIGS global protocol buffer component 504 and its recipient 505 enables real time synchronisation with the RTGS global platform. The RTGS global protocol buffer component also ensures real time synchronisation between the RTGS global platform and the participating bank

In FIG. 5 a representation of liquidity pools, held by a participating bank within a specific jurisdiction is shown. The necessary liquidity requirements 507 are checked to facilitate a cross border payment after a foreign exchange rate locking service 508, has been applied.

The foreign exchange rate locking service 508 checks that pre-configured participating banks 512 are accorded a rate which applies to a cross-border transaction initiated at the participating banks 501. Many recipient banks may be available to the sending bank 501, however in this illustration just one recipient bank is shown to provide liquidity necessary to complete the transaction, 512.

Once a rate is selected by the sending participating bank 501, the rate and data relating to the transaction are time-locked by a processor 508 and applied across the RTGS global platform. This allows any required liquidity calculations to be completed and a liquidity lock put in place in respect of the parties, the sum of funds and the rate.

A message indicating that the liquidity locks are in place is then transmitted to both participating banks 501 and 512. Once locked using the RTGS global system 500, a liquidity available balance is decremented within the RIGS global projection of liquidity for both banks. This ensures records accurately represent liquidity for other transactions that take place.

These records may be incorporated into and include a distributed ledger which is ideally spread across a number of independent sites and/or in different countries and/or in independent institutions and is often referred to as the ‘blockchain’. The ‘blockchain’ therefore records the liquidity lock of the transaction and the known liquid funds that are required to complete the transaction on both jurisdictions.

Referring again to FIG. 5 the same notification message is executed within the participating banks 501 and 512 and a representation of the projection of liquidity pools at the sending participating bank is shown at 510. A representation 509 of the required liquidity that must be locked in order to facilitate a transaction is now referred to as locked liquidity.

The RTGS global protocol buffer component 511 with 513 also ensures synchronisation with the participating bank 512 and that the participating bank is able and will facilitate the transaction within that jurisdiction when called upon to do so.

The RIGS global protocol buffer component 513 maintains the participating bank 512 and the RTGS global platform 500 in synchronisation one with another thereby ensuring there is a true representation of liquidity pools of participants within a particular jurisdiction.

When a rate is accepted liquidity is locked 515 so as to facilitate the transaction. At this moment the bank 501 executes a payment transaction 516. A message 516 confirming this is relayed via the protocol buffer component 504 to the RTGS global platform 500 and is received via its protocol buffer 505.

Completion of the transaction is indicated at 517 where data for the “final leg” of the transaction, is transferred and this allows the participating bank 512 to complete the payment using its local banking and payment rails within its local jurisdiction. A status message 518 confirms the outcome of the transaction and provides a tracking history of the full ‘end to end’ payment, including data on the final leg of the transaction. This status message 518 is sent to the RTGS global system 500 ready for routing back to the initiating participating bank 501. This is shown in FIG. 5 as 519 which indicates that the status message has been passed by the participating beneficiary bank 512 via the RTGS global system 500.

A service relay 520 is used to pass on any status messages to the customer who initiated the payment. This is also executed by the participating bank 501 rather than by the RTGS global network, though the RTGS global network may in some instances relay status messages directly.

Each transaction between every bank user of the RTGS global network operates in real-time, even at weekends, including to banks that are disconnected from their own real-time gross settlement (RTGS) systems. In such cases control software in the RTGS global system 500 authorises transaction messages with a netting occurring automatically when a domestic RTGS next comes online, for example on Monday morning after a weekend.

Reporting to central banks is also managed in real time, and as such end of day fixed and guaranteed liquidity positions are confirmed by the RTGS global system. In the event of a member bank resolution, this capability removes Herstatt risk from the RTGS global managed transactions. In addition, this capability can be used to report and confirm end of day or alternative time periods to central banks, regulators and resolution authorities.

RTGS global connects to national RTGS platforms. It is anticipated that in due course the RTGS global system will connect with key national RTGS systems operated by the central banking authorities and deliver simultaneous real-time messaging to central bank money accounts. This is in addition to also holding a real-time view on nostro/vostro accounts held within the national banks of a jurisdiction.

The benefit of this development is that the liquidity positions move quickly and seamlessly within to and from a central bank in real time, and at that stage, RTGS global may adapt to a payment scheme, specifically to support cross border real-time payments.

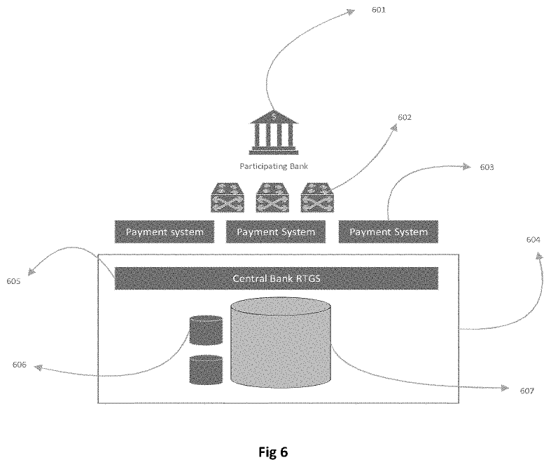

Referring to FIG. 6 there is illustrated diagrammatically the cost savings on foreign exchange versus risk as a consequence of the role of national banks in the RTGS global system.

At the commencement of operations, the role of a key national banks with direct connections to the domestic payment systems and local network rails is required. A participating bank 601 is within a jurisdiction. A payment system 602 connects the bank 601 to technologies that typically include: TCP/IP gateways, VPN or SWIFT.

A representation of a local payment system 603 that the participating bank is a member of a central bank 604 within that jurisdiction. The central bank RTGS system 605 controls funds across the direct central bank members and for money movements triggered by local payment systems 603.

A collateral account 606 is one into which some payment systems operate, for example faster payments service (FPS) within the UK.

A participating bank account 607 is where money is held within the central bank. RTGS 605 moves monies between participating banks accounts. It is apparent that a real time connection is a key to delivery of the RTGS global service. National banks are expected to have direct national payment schemes connections and straight through processing capabilities. These enable payments received by the national banks to be settled or processed into the RTGS global network

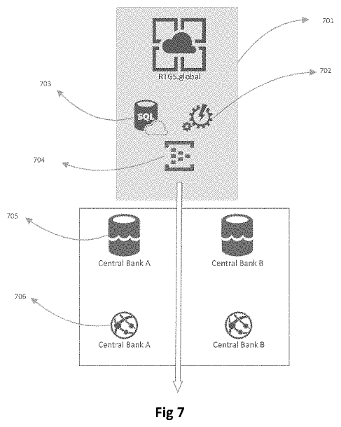

The role of central banks in RTGS global is shown in FIG. 7. Central Banks maintain their prudential regulatory responsibilities within the RTGS global network. The RTGS global platform 701 permits the configuration of services that allow central banks to set currency controls, based on transactional “flow” and or a “transactional value”. This control ensures transactions that trigger these rules cannot be processed and are stopped at source which is important as it ensures that transactions only occur when permitted and authorised by a RTGS global controller 702

A global transactional record 703 of all relevant transactions is made via the RTGS or global network 701. 703 may be implemented using distributed ledger technology (blockchain). An event-based controller 704 is used to track and record RTGS global events so that they can be used by any other connected components, either for data storage in a database, blockchain, or to trigger processing activities. An advantage of this feature is that it also allows subscription to events and associated data by central banks which may be important for regulatory purposes or planning.

A data lake 705 is delivered in a specific jurisdiction to a central bank. This has transactional events streamed into it in real time by subscribing to 704, which may also be logged but importantly are able to be accessed in order to help determine liquidity and potential exposure and risks.

A web-based portal 706 delivers data to be used by and to enable a central bank to configure transactional throttling based on flow or value. 706 assists in providing clarity into liquidity pools and fund allocations across the RTGS global network for participating banks within that central bank's jurisdiction only.

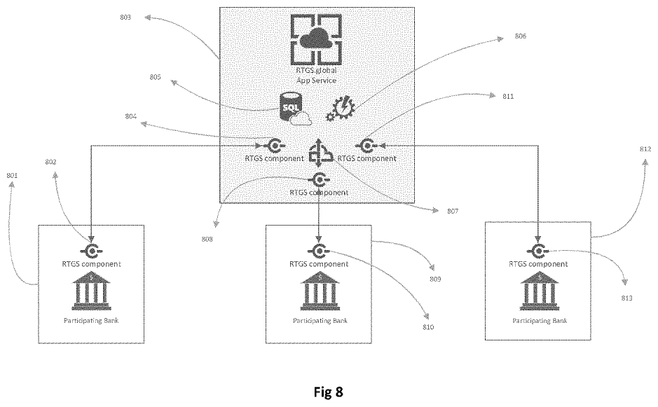

Referring to FIG. 8 which depicts an example of a RTGS global correspondent banking model and shows when a bank 812 sells its own currency, it receives a currency payment in the currency of a purchasing bank 809 in this model. This is normally deposited within a safeguarding or ringfenced account within the nostro vostro model held effectively on trust or ESCROW by the purchasing bank in favour of the selling bank. A participant bank 801 initiates a cross border payment. The participant bank 801 does not wish to hold or is unable to hold the destination currency of the bank 812 to where funds are being transmitted.

An RTGS global protocol buffer component 802 is used for bi-directional communication and synchronisation between the participant bank 801 and the RTGS global platform 803.

RTGS global protocol buffer component 804 is operative to receive and send bi-directional messaging including synchronisation tasks and instructions between the participant bank 801 and the RTGS global platform 803 in accordance with correspondence routing rules 805. These routing rules 805 are the rules used to identify which bank holds which currencies.

The RTGS global currency matching and routing engine 806 is used to match participating banks with specific currencies, enabling a transaction to be completed by a participant who wishes to offload the currency matching and FX to a secondary participant in the RTGS global network.

A protocol buffer service relay 807 relays transactional messages from a participant bank 801 to another participant bank 809 and then onto a third and subsequent participant bank 812. The RTGS global protocol buffer component 808 is deployed for bi-directional communication and synchronisation needs between the participants 801, 812 and the RTGS global platform 803.

Where participant bank 809 holds necessary destination and initiating fiat currency data the RTGS global protocol buffer component 810 is used to oversee bi-directional communication and synchronisation between the participant banks and the RTGS global platform 803.

RTGS global protocol buffer component ensures that the RTGS global platform checks that the participant bank, holding the fiat currency needed to complete the transaction, has the funds and the RTGS global protocol buffer component checks that these are ringfenced for the appropriate time period pending acceptance.

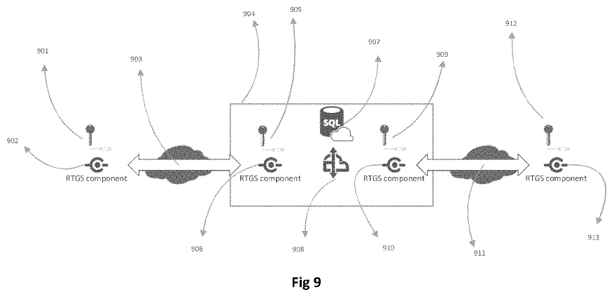

FIG. 9 is an overall diagrammatic view of an RTGS global network security system and shows a participant bank 901 which employs a private key 901 for point to point encryption and communication between the RTGS global protocol buffer components.

this arrangement the RTGS global protocol buffer 902, only enables communications with configured RTGS global protocol buffers 906 within the RTGS global platform. This is achieved by way of encrypted communication (HTTPS) 903 over the Internet via the RTGS global platform 904.

A corresponding key 905, for participant bank communications, is supplied by RTGS global protocol buffer 906. Encryption offloading is moved to the “edge” of the platform 904 and hence all internal communications are now able to be channelled over a private infrastructure, such as a virtual private network (VPN) which is end-to-end fully encrypted. An audit log 907 of all communications between RTGS global protocol buffers is compiled. A service relay 908 is operative to move messages between protocol buffers 906 and 910.

Edge encryption is carried at with a corresponding key 909 operating in conjunction with RTGS global protocol buffer component 910. Encrypted communication (HTTPS) 911 are transacted over the internet between RTGS global and the participant banks protocol buffer 913. A private key 912 is used at the participant bank to ensure all communications are secured. This configuration ensures end to end encryption between participating banks that do not correspond or share any security information with each other.

Funds can only be moved between these two points, ensuring funds cannot be moved to a third bank, either a participating bank or not.

RTGS global interbank billing is carried out using a processor and billing facilities which are in communication with distributed ledgers located at independent sites.

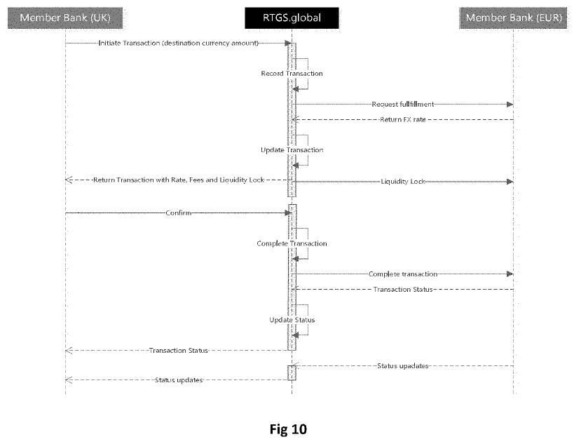

FIG. 10 shows a first participant bank (Member Bank UK) whose membership is within the UK jurisdiction (fiat currency GBP). A transaction initiation is sent to RTGS global which records the transaction details. The transaction request is then sent as a fulfilment message to a second participant bank (Member Bank EUR) whose membership is within the EURO jurisdiction (fiat currency EURO). An FX rate is confirmed and sent back to RTGS global. The RTGS global system updates the transaction details and performs a liquidity lock on both first and second participant banks.

The ultimate customer confirms the transaction, which is also confirmed by the first participant bank, and RTGS global completes the transaction and sends to the second participant bank the complete transaction message. The second participant bank sends a return message with the transaction status back to RTGS global which maintains and updates the transaction status. RTGS global then relays the message of the transaction status back to the first participant bank.

Additional transaction status updates can be triggered by the second participant bank, back to RTGS global which relays these onto the first participant bank.

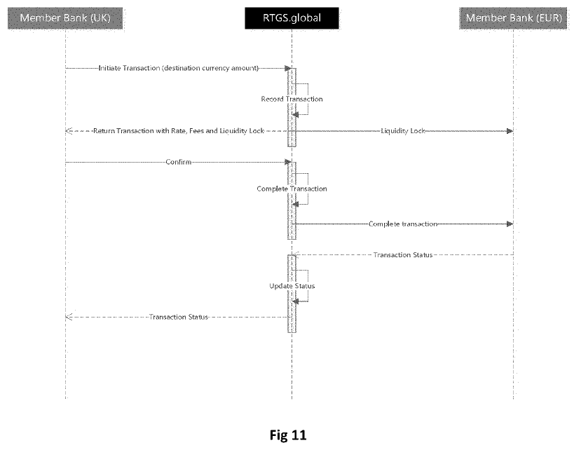

FIG. 11 shows a first participant bank (Member bank UK) whose membership is within the UK jurisdiction (fiat currency GBP) initiating a transaction. This message is sent to RTGS global which records the transaction. The RTGS global system has pre-configured information on FX rates and transactional based fees. The RTGS global system also has a view and records a known state of necessary liquidity at the first participant bank and at the second participant bank (Member Bank EUR), whose membership is within the EURO jurisdiction (fiat currency EURO). RTGS global performs a liquidity lock at both the first and second participant banks.

The ultimate customer confirms the transaction and the first participant bank sends the confirmation to RTGS global, which completes the transaction. The transaction completion message is then sent onto the second participant bank. The second participant bank sends transaction status message back to the RTGS global system, which updates the transaction status before relaying the transaction status update to the first participant bank.

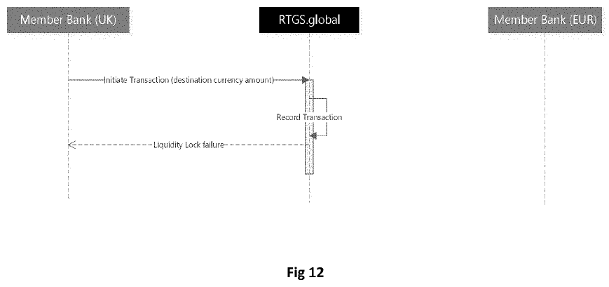

FIG. 12 shows a first participant bank (Member Bank UK) whose membership is within the UK jurisdiction (fiat currency GBP) initiating a transaction. The message is sent to RTGS global which records the transaction. However, RTGS global has overall view and therefore is able to provide verification of necessary liquidity at both the first participant bank and the second participant bank (Member Bank EUR) whose membership is within the EURO jurisdiction (fiat currency EURO).

In this example, there is insufficient liquidity, and therefore a liquidity lock cannot be performed at either one of the participant banks. A liquidity lock failure message is therefore sent back to the first participant bank from RTGS global.

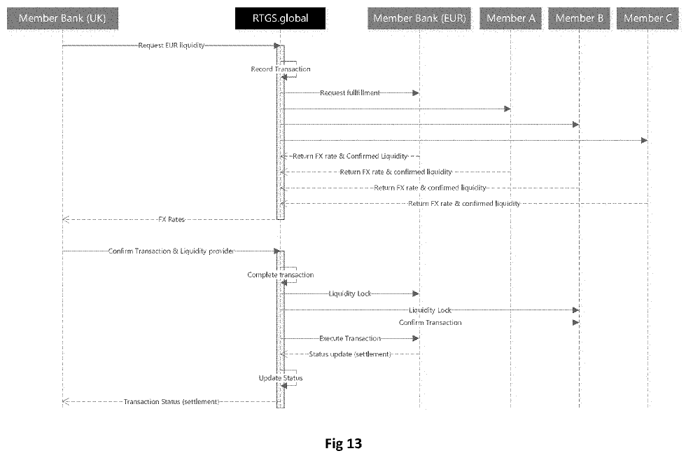

FIG. 13 shows how the RTGS global network can be used for participants to purchase liquidity in fiat currency across the network of participant banks. In this example, a first participant bank (Member Bank UK) whose membership is within the UK Jurisdiction (fiat currency GBP) wishes to purchase EURO liquidity.

A request is sent to the RTGS global system. The RTGS global system records the transaction and sends out fulfilment request messages to a second participant bank (Member Bank EUR) whose jurisdiction is within the EURO zone (fiat currency EURO), and other participant banks (Member A, B and C), participant bank three, four and five respectively. Participant banks three, four and five each hold EURO liquidity within the second participant bank (Member Bank EUR).

Participant banks two, three, four and five all send back their FX rate and confirmed liquidity messages. The FX rates are relayed back the first participant bank.

The first participant bank confirms the transaction and a preferred liquidity partner. This message is sent to the RTGS global system which records the transaction. A liquidity lock is placed on the second participant bank that holds the EURO currency. A second liquidity lock is placed on the fourth participant bank (member bank B) that is providing the liquidity. The transaction confirmation is then sent from the RTGS global system to the fourth participant bank (member bank B) and a transaction execution message is sent to the second participant bank (member bank EUR).

The second participant bank sends a status message (relating to settlement) back to the RIGS global system which updates the transaction status before relaying the status and settlement of the transaction back to the first participant bank.

The invention has been described by way of examples only, and it will be appreciated that variation to the embodiments may be made, without departing from the scope of protection as defined by the claims.

1-46. (canceled)

47. A method of synchronizing financial transaction data between internationally-disparate initiating and beneficiary computer systems, comprising:
presenting, from an RTGS computer system, a plurality of possible foreign exchange rates to an initiating computer system;
selecting, by the initiating computer system, one of the plurality of possible foreign exchange rates at the RTGS computer system for use to complete a given financial transaction;
time-locking by the RTGS computer system the selected one of the plurality of possible foreign exchange rate and transaction data corresponding to the given financial transaction;
storing, in a distributed ledger database spread across a plurality of independent computer systems, a timed liquidity lock to ringfence an amount in an account associated with the initiating computer system sufficient to satisfy the given transaction, the timed liquidity lock having a fixed time period of no more than 30 seconds;
after the storing in the distributed ledger database, transmitting a message from the RTGS to both the initiating computer system and a receiving computer system indicating that the timed liquidity lock has been activated;
facilitating completion of the given transaction between the initiating computer system and the receiving computer system at the selected one of the plurality of possible foreign exchange rates within the fixed time period; and
receiving a status message, from the receiving computer system to the RTGS computer system, indicating a completion of the given transaction prior to expiration of the fixed time period,
wherein the ringfence times-out after the fixed time period to prevent the RTGS computer system from completing the given transaction after the fixed time period.

48. The method of synchronizing financial transaction data between internationally-disparate initiating and beneficiary computer systems according to claim 47, wherein:
the given transaction is an individual peer-to-peer transaction.

49. The method of synchronizing financial transaction data between internationally-disparate initiating and beneficiary computer systems according to claim 47, wherein:
the distributed ledger is a Blockchain ledger.

50. The method of synchronizing financial transaction data between internationally-disparate initiating and beneficiary computer systems according to claim 47, wherein:
the plurality of individual computer systems are spread across a plurality of different countries.

51. The method of synchronizing financial transaction data between internationally-disparate initiating and beneficiary computer systems according to claim 47, wherein:
the plurality of individual computer systems are spread across a plurality of independently-secured computer systems.

52. The method of synchronizing financial transaction data between internationally-disparate initiating and beneficiary computer systems according to claim 47, wherein:
the fixed time period of the timed liquidity lock is no more than 20 seconds.

53. The method of synchronizing financial transaction data between internationally-disparate initiating and beneficiary computer systems according to claim 47, wherein:
the fixed time period of the timed liquidity lock is no more than 8 seconds.

54. A non-transient computer-readable storage medium having stored thereon instructions that, when executed by a processing system, configure the processing system to:
present, from an RTGS computer system, a plurality of possible foreign exchange rates to an initiating computer system;
select, by the initiating computer system, one of the plurality of possible foreign exchange rates at the RTGS computer system for use to complete a given financial transaction;
time-lock by the RTGS computer system the selected one of the plurality of possible foreign exchange rate and transaction data corresponding to the given financial transaction;
store, in a distributed ledger database spread across a plurality of independent computer systems, a timed liquidity lock to ringfence an amount in an account associated with the initiating computer system sufficient to satisfy the given transaction, the timed liquidity lock having a fixed time period of no more than 30 seconds;
after the storing in the distributed ledger database, transmit a message from the RTGS to both the initiating computer system and a receiving computer system indicating that the timed liquidity lock has been activated;
facilitate completion of the given transaction between the initiating computer system and the receiving computer system at the selected one of the plurality of possible foreign exchange rates within the fixed time period; and
receive a status message, from the receiving computer system to the RTGS computer system, indicating a completion of the given transaction prior to expiration of the fixed time period,
wherein the ringfence times-out after the fixed time period to prevent the RTGS computer system from completing the given transaction after the fixed time period.

55. The non-transient computer-readable storage medium having stored thereon instructions that, when executed by a processing system, configure the processing system according to claim 54, wherein:
the given transaction is an individual peer-to-peer transaction.

56. The non-transient computer-readable storage medium having stored thereon instructions that, when executed by a processing system, configure the processing system according to claim 54, wherein:
the distributed ledger is a Blockchain ledger.

57. The non-transient computer-readable storage medium having stored thereon instructions that, when executed by a processing system, configure the processing system according to claim 54, wherein:
the plurality of individual computer systems are spread across a plurality of different countries.

58. The non-transient computer-readable storage medium having stored thereon instructions that, when executed by a processing system, configure the processing system according to claim 54, wherein:
the plurality of individual computer systems are spread across a plurality of independently-secured computer systems.

59. The non-transient computer-readable storage medium having stored thereon instructions that, when executed by a processing system, configure the processing system according to claim 54, wherein:
the fixed time period of the timed liquidity lock is no more than 20 seconds.

60. The non-transient computer-readable storage medium having stored thereon instructions that, when executed by a processing system, configure the processing system according to claim 54, wherein:
the fixed time period of the timed liquidity lock is no more than 8 seconds.
